(19) United States
(12) Patent Application Publication
(10) Pub. No.: US 2025/0149838 A1
(43) Pub. Date: May 8, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masami SAKAI, Osaka (JP); Liping KANG, Mie (JP)

(21) Appl. No.: 18/836,008

(22) PCT Filed: Jan. 17, 2023
(86) PCT No.: PCT/JP2023/001084

§ 371 Date: Aug. 6, 2024

(30) Foreign Application Priority Data
Feb. 7, 2022 (JP) 2022-016974

(51) Int. Cl. H01R 24/44; H01R 103/00

(52) U.S. Cl. CPC H01R 24/44; H01R 2103/00

(57) ABSTRACT

A connector (10) includes an outer conductor having a hollow cylindrical shape and to be crimped to an end part of a shielded wire (W) including a core wire (51). The outer conductor (15) is divided into two including one first region (15K) and one second region (15L) in a circumferential direction. The outer conductor (15) includes a fixed contact point portion (15H) provided in the first region (15K), fixed in position with respect to the first region (15K) and configured to contact an inner surface of a mating outer conductor (65), and a resilient contact point portion (15J) provided in the second region (15L) and configured to resiliently contact the inner surface of the mating outer conductor (65).

### TECHNICAL FIELD

The present disclosure relates to a connector.

### BACKGROUND

Patent Document 1 discloses a coaxial connector. This connector includes a hollow cylindrical shell having a base end part to be crimped to an outer conductor of a coaxial cable. Slits extending in an axial direction are formed side by side at equal intervals in a circumferential direction on a tip part of the shell. This makes parts between adjacent ones of the slits resiliently deformable. When the tip part of the shell is inserted into a mating receptacle, the parts between the adjacent ones of the slits resiliently contact the inner surface of the receptacle.

### PRIOR ART DOCUMENT

### Patent Document

Patent Document 1: JP 2021-051872 A
Patent Document 2: U.S. Pat. No. 10,348,044 B2

### SUMMARY OF THE INVENTION

### Problems to be Solved

The tip part of the shell of Patent Document 1 resiliently contacts the inner surface of the receptacle over an entire periphery. Thus, with the connector of Patent Document 1, it may be difficult to determine the radial position of the tip part of the shell with respect to the receptacle.

A connector of the present disclosure was completed on the basis of the above situation and it is aimed to provide a connector facilitating position determination at the time of connection and satisfactorily connectable.

### Means to Solve the Problem

The present disclosure is directed to a connector with an outer conductor having a hollow cylindrical shape, the outer conductor being crimped to an end part of a cable including a core wire, the outer conductor being divided into two including one first region and one second region in a circumferential direction, the outer conductor including a fixed contact point portion provided in the first region, the fixed contact point portion being fixed in position with respect to the first region, the fixed contact point portion contacting a peripheral surface of a mating outer conductor, and a resilient contact point portion provided in the second region, the resilient contact point portion resiliently contacting the peripheral surface of the mating outer conductor.

### Effect of the Invention

According to the present disclosure, position determination at the time of connection is facilitated and satisfactory connection can be achieved.

### BRIEF DESCRIPTION OF THE DRAWINGS

FIG. 1 is a side view in section of a connector of the present disclosure.

FIG. 2 is a section along A-A in FIG. 1.

FIG. 3 is a side view of a first region of a fourth tube portion when viewed from a direction orthogonal to an axis.

FIG. 4 is a side view of a second region of the fourth tube portion when viewed from the direction orthogonal to the axis.

FIG. 5 is a side view showing a state where a second outer conductor having a dielectric inserted therein is externally fit to a first outer conductor.

FIG. 6 is a side view in section of a mating connector.

FIG. 7 is a side view in section showing a state where the connector of the present disclosure and the mating connector are connected.

FIG. 8 is a section along B-B in FIG. 7.

FIG. 9 is a side view showing a state where the fourth tube portion of the second outer conductor is inserted in a mating outer conductor.

### DETAILED DESCRIPTION TO EXECUTE THE INVENTION

### Description of Embodiments of Present Disclosure

First, embodiments of the present disclosure are listed and described.
(1) The connector of the present disclosure is provided with an outer conductor having a hollow cylindrical shape, the outer conductor being crimped to an end part of a cable including a core wire. The outer conductor is divided into two including one first region and one second region in a circumferential direction. The outer conductor includes a fixed contact point portion provided in the first region, the fixed contact point portion being fixed in position with respect to the first region, the fixed contact point portion contacting a peripheral surface of a mating outer conductor, and a resilient contact point portion provided in the second region, the resilient contact point portion resiliently contacting the peripheral surface of the mating outer conductor.

According to this configuration, since the fixed contact point portion in the first region is maintained in contact with the peripheral surface of the mating outer conductor by the resilient contact of the resilient contact point portion in the second region with the peripheral surface of the mating outer conductor, the positions of the mating outer conductor and the outer conductor are easily determined in a radial direction.
(2) Preferably, a plurality of the resilient contact point portions are defined by slits formed in the second region and arranged side by side in the circumferential direction. Adjacent resilient contact point portions are facing one common slit. According to this configuration, since the adjacent resilient contact point portions are partitioned by one slit, a dimension between the adjacent resilient contact point portions can be easily narrowed, whereby an area of the slit can be reduced. Thus, an impedance difference can be easily suppressed to be small between a part where the slits are formed and a part where the slits are not formed in an axial direction of the outer conductor.
(3) Preferably, in (2), the outer conductor is inserted into the mating outer conductor, and the slits are surrounded by the mating outer conductor. According to this configuration, since the slits are surrounded by the mating outer conductor, the leakage of electromagnetic noise through the slits can be prevented and shielding performance can be improved.
(4) Preferably, a dielectric to be arranged inside the outer conductor is provided. A thickness in the radial direction of a part facing an inner surface of the first region, out of the dielectric, is larger than a thickness in the radial direction of a part facing an inner surface of the second region, out of the dielectric. According to this configuration, such as when an impedance on the side of the second region is high, a total impedance in the radial direction can be brought closer to a target magnitude by reducing an impedance on the side of the first region.
(5) Preferably, in (4) directly or indirectly dependent on (2), a coupling slit partitioning between an end of the resilient contact point portion in an axial direction of the core wire and the outer conductor and connected to the slits is formed in the second region, the connector includes an inner conductor, a mating tab being inserted into the inner conductor, an exposed part exposed from the inner conductor, out of the tab, being accommodated in the dielectric, and the coupling slit and the exposed part of the tab are different in position in the axial direction of the core wire. An impedance tends to be high at a position of the outer conductor where the slits are formed and in the exposed part of the tab. Thus, if these positions are aligned in the axial direction of the core wire, an impedance at that position excessively increases. According to this configuration, since these positions are made different, it is possible to prevent the formation of a part where an impedance excessively increases.
(6) Preferably, a deflection space is formed inside the second region, the resilient contact point portion being insertable into the deflection space when being resiliently deformed. According to this configuration, the resilient deformation of the resilient contact point portion can be made less likely to be hindered by the deflection space.

### DETAILS OF EMBODIMENT OF PRESENT DISCLOSURE

### Embodiment

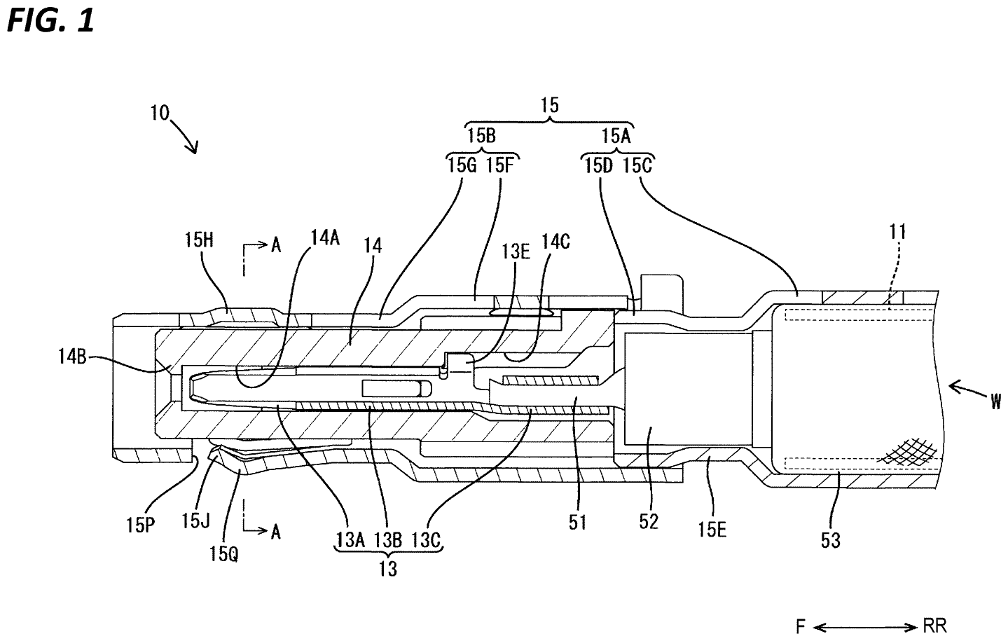

One embodiment of a technique disclosed in this specification is described with reference to FIGS. 1 to 9. In the following description, right and left sides shown in FIG. 1 are defined as front and rear sides concerning a front-rear direction. The front side is a side where a mating connector 60 is located with respect to a connector 10.

### [Configuration of Connector]

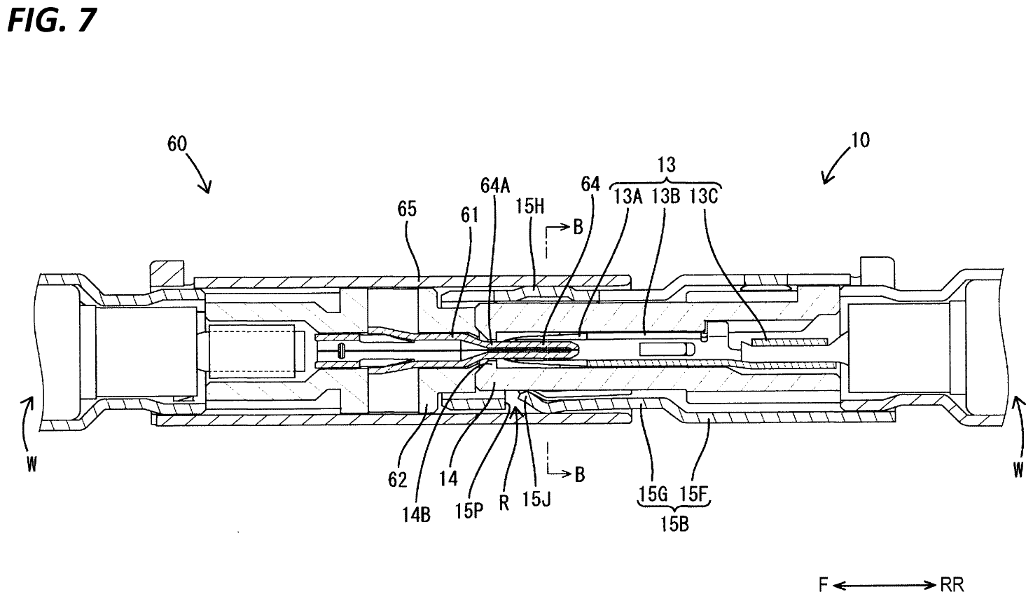

As shown in FIG. 1, the connector 10 is provided with a sleeve 11, an inner conductor 13, a dielectric 14 and an outer conductor 15. The connector 10 is mounted on an end part of a shielded wire W. The outer conductor 15 includes a first outer conductor 15A and a second outer conductor 15B. The sleeve 11, the first outer conductor 15A, the inner conductor 13 and the second outer conductor 15B are made of metal. The dielectric 14 is made of synthetic resin. The connector 10 is electrically connected to the mating connector 60 (see FIG. 7).

The shielded wire W, which is a cable, is a so-called coaxial wire. The shielded wire W includes an electrically conductive core wire 51 formed by twisting a plurality of strands, an insulating coating 52 surrounding the outer periphery of the core wire 51, an electrically conductive braided wire 53 surrounding the outer periphery of the coating 52 and formed by braiding strands into a net, and an insulating sheath surrounding the outer periphery of the braided wire 53. The core wire 51 has a function of transmitting a high-frequency signal. The braided wire 53 has a function of shielding electromagnetic waves. The shielded wire W is formed such that the core wire 51 and the braided wire 53 are successively exposed from a tip side by stripping the sheath and the coating 52.

The sleeve 11 has an annular shape. The sleeve 11 is arranged to surround the outer periphery of the braided wire 53 and has an outer surface covered by a front end part of the folded braided wire 53. The sleeve 11 has a function of receiving a crimping load.

The inner conductor 13 is formed, such as by bending a metal plate. The inner conductor 13 is configured by successively connecting a mating connecting portion 13A, a tubular portion 13B and a center conductor crimping portion 13C from a front side to a rear side.

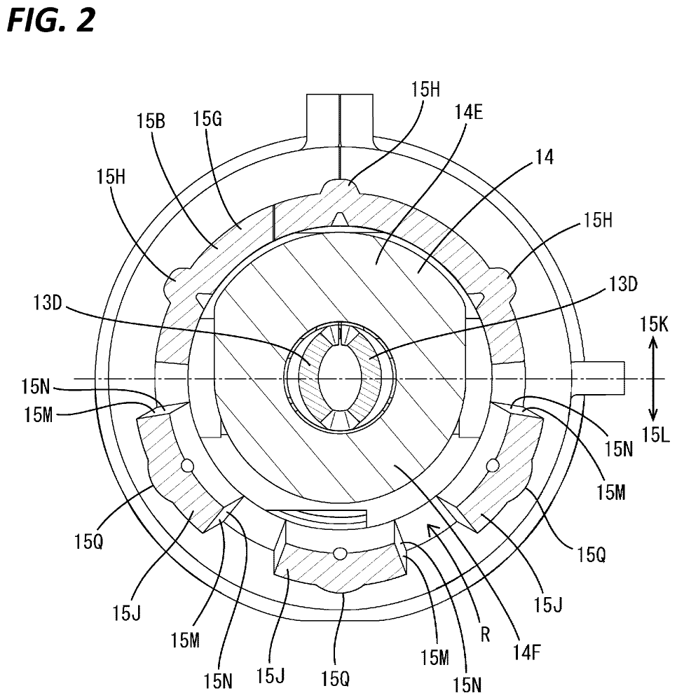

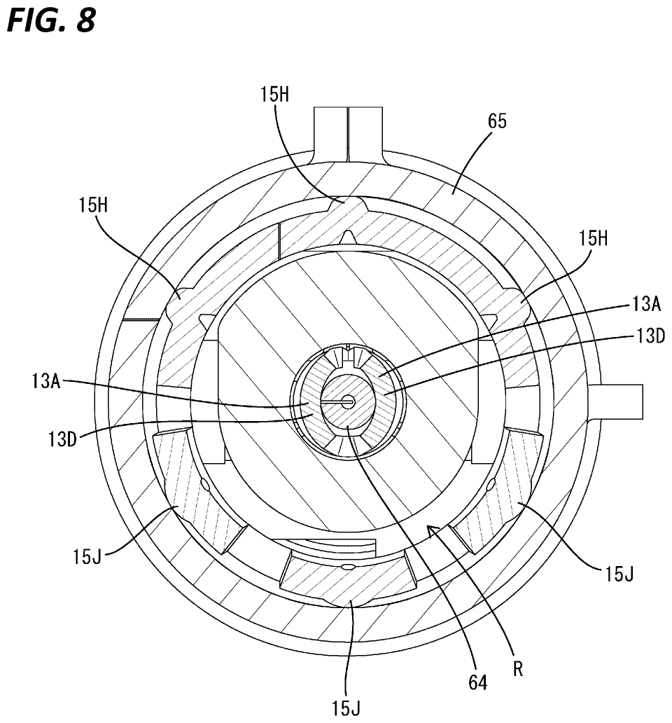

The tubular portion 13B has a hollow cylindrical shape elongated in the front-rear direction. The mating connecting portion 13A is constituted by a pair of resilient pieces 13D projecting forward from the tubular portion 13B (see FIG. 2). The respective resilient pieces 13D are arranged to face each other across an axis of the tubular portion 13B. A tab 64 of a mating inner conductor 61 is inserted into the mating connecting portion 13A. The tab 64 of the mating inner conductor 61 is inserted between the respective resilient pieces 13D, and the respective resilient pieces 13D are expanded to guide the tab 64 and radially sandwich the tab 64 (see FIG. 8). The center conductor crimping portion 13C is in the form of an open barrel and connected to the rear end of the tubular portion 13B. The exposed core wire 51 of the shielded wire W is inserted into the center conductor crimping portion 13C. The center conductor crimping portion 13C is crimped to the core wire 51, whereby the inner conductor 13 and the core wire 51 are coupled.

The dielectric 14 has a tubular shape and is formed with an inner conductor insertion hole 14A penetrating in the front-rear direction and having a circular cross-section. A thick portion 14B formed to reduce an inner diameter of the inner conductor insertion hole 14A is provided in a front end part of the dielectric 14. The thick portion 14B has a larger thickness in a radial direction from an axis of the core wire 51 than other parts in the dielectric 14. The inner conductor 13 is inserted into the inner conductor insertion hole 14A of the dielectric 14 from behind. The inner conductor 13 is provided with a contact stop portion 13E, and the contact stop portion 13E comes into contact with the front end of a contact stop receiving portion 14C formed in the inner insertion hole 14E, whereby the inner conductor 13 is prevented from moving any further forward with respect to the dielectric 14.

As shown in FIGS. 1 and 2, a front side in the axial direction of the dielectric 14 is formed to be thicker on one side than the other side in a circumferential direction. The front side in the axial direction of the dielectric 14 is formed to be gradually thicker from the other side (lower side in FIG. 2) toward the one side (upper side in FIG. 2).

The first outer conductor 15A is formed into a hollow cylindrical shape, such as by bending a metal plate. As shown in FIG. 1, the first outer conductor 15A includes a first tube portion 15C and a second tube portion 15D located forward of the first tube portion 15C. The first and second tube portions 15C, 15D are coaxially arranged. An outer diameter of the first tube portion 15C is larger than that of the second tube portion 15D. A reduced diameter portion 15E is formed between the first and second tube portions 15C, 15D. An outer diameter of the reduced diameter portion 15E is smaller than those of the first and second tube portions 15C, 15D. The first tube portion 15C surrounds the sleeve 11 covered by the front end part of the folded braided wire 53. The second tube portion 15D is arranged forward of the first tube portion 15C on an end part of the coating 52 of the shielded wire W. The first outer conductor 15A is coupled to the shielded wire W by being crimped to the sheath of the shielded wire W. The rear end of the dielectric 14 is arranged adjacent to the tip of the second tube portion 15D. A rear end part of the dielectric 14 surrounds the core wire 51.

The second outer conductor 15B is formed into a hollow cylindrical shape, such as by bending a metal plate. The second outer conductor 15B includes a third tube portion 15F and a fourth tube portion 15G located forward of the third tube portion 15F. The third and fourth tube portions 15F, 15G are coaxially arranged. An outer diameter of the third tube portion 15F is larger than that of the fourth tube portion 15G. The second tube portion 15D of the first outer conductor 15A is fit into the third tube portion 15F. The fourth tube portion 15G is located forward of the third tube portion 15F. The fourth tube portion 15G is divided into two including a first region 15K and a second region 15L (see FIG. 2). The first region 15K is one of two regions obtained by dividing the second outer conductor 15B into two in the circumferential direction (see FIG. 2). The second region 15L is the other of the two regions obtained by dividing the second outer conductor 15B into two in the circumferential direction (see FIG. 2). The first and second regions 15K, 15L have a semicircular shape or the like.

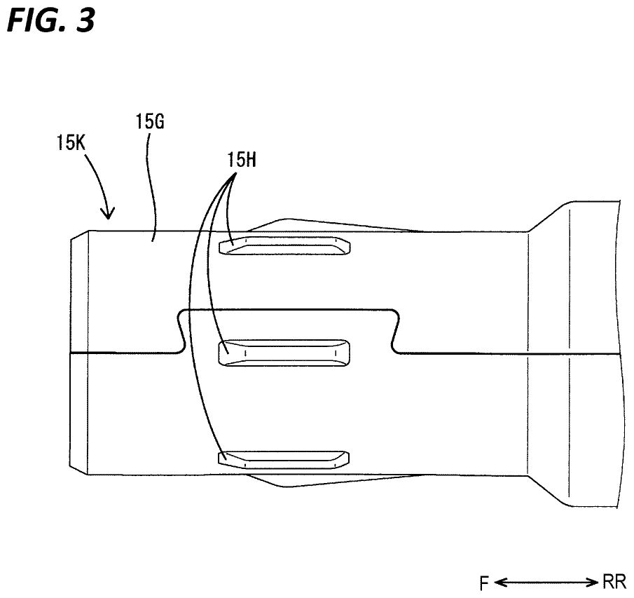

As shown in FIGS. 2, 3 and 4, the fourth tube portion 15G is provided with three fixed contact point portions 15H and three resilient contact point portions 15J. The three fixed contact point portions 15H are provided only in the first region 15K (see FIG. 2). These fixed contact point portions 15H are formed to extend in an axial direction of the second outer conductor 15B and project in a radial direction from an axis of the second outer conductor 15B (see FIGS. 2 and 3). These fixed contact point portions 15H are arranged side by side at equal intervals in the circumferential direction (see FIG. 2). These fixed contact point portions 15H are fixed in position with respect to the first region 15K. That is, the fixed contact point portions 15H are not relatively displaced with respect to the second outer conductor 15B.

The three resilient contact point portions 15J are provided in the second region 15L (see FIG. 2). That is, the fourth tube portion 15G of the second outer conductor 15B is divided into two including one first region 15K and one second region 15L in the circumferential direction. These resilient contact point portions 15J are defined by slits 15M formed in the second region 15L and arranged side by side in the circumferential direction.

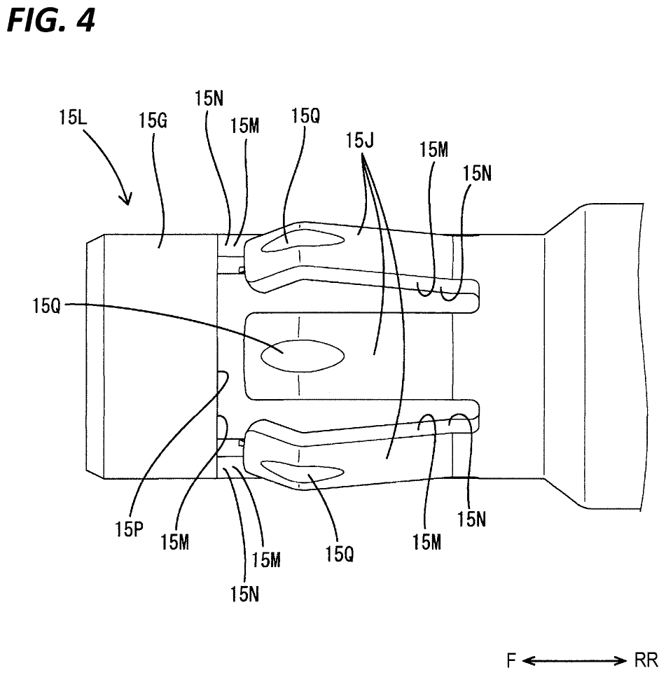

The slits 15M are formed by four defining slits 15N extending in the axial direction of the second outer conductor 15B and a coupling slit 15P extending in the circumferential direction and coupling front end parts of these defining slits 15N to each other (see FIG. 4). The coupling slit 15P is formed in the second region 15L. The coupling slit 15P is connected to each defining slit 15N (see FIG. 4). The coupling slit 15P partitions between the front ends of the resilient contact point portions 15J in the axial direction of the core wire 51 and the fourth tube portion 15G of the second outer conductor 15B (see FIG. 4). The coupling slip 15P and the thick portion 14B of the dielectric 14 are different in position in the axial direction of the core wire 51 (see FIG. 1).

One resilient contact point portion 15J is arranged between adjacent ones of the defining slits 15N and resiliently deformable in the radial direction with a rear end as a supporting point. Each resilient contact point portion 15J is formed to gradually expand outward (in a direction separated from an axis of the fourth tube portion 15G) from the rear end to a front end part, and the front end part is bent inward (in a direction approaching the axis of the fourth tube portion 15G). Each resilient contact point portion 15J is formed into a chevron shape projecting outward. In the fourth tube portion 15G, the front end of each resilient contact point portion 15J is located closer to the third tube portion 15F than (rearward of) the front end of the fixed contact point portion 15H (see FIG. 1). A rounded bead 15Q projecting to bulge outward is formed on a top part of each chevron-shaped resilient contact point portion 15J. In the fourth tube portion 15G, each bead 15Q is located closer to the third tube portion 15F than (rearward of) the front end of the resilient contact point portion 15J and located closer to the third tube portion 15F than (rearward of) the front end of the fixed contact point portion 15H (see FIG. 1). The resilient contact point portions 15J adjacent in the circumferential direction are facing one common defining slit 15N (see FIG. 4).

As shown in FIG. 2, the three fixed contact point portions 15H and three beads 15Q are arranged at equal intervals in the circumferential direction. One fixed contact point portion 15H and one bead 15Q are arranged on opposite sides across the axis of the fourth tube portion 15G of the second outer conductor 15B. When the second outer conductor 15B is inserted into the mating outer conductor 65, the three fixed contact point portions 15H contact an inner surface, which is the peripheral surface of the mating outer conductor 65. Along with this, the three beads 15Q resiliently contact the inner surface, which is the peripheral surface of the mating outer conductor 65 (see FIG. 8). In this way, the three fixed contact point portions 15H and the three beads 15Q of the second outer conductor 15B can be held to have a certain positional relationship (i.e. coaxial positional relationship) in the radial direction and reliably contact the mating outer conductor 65.

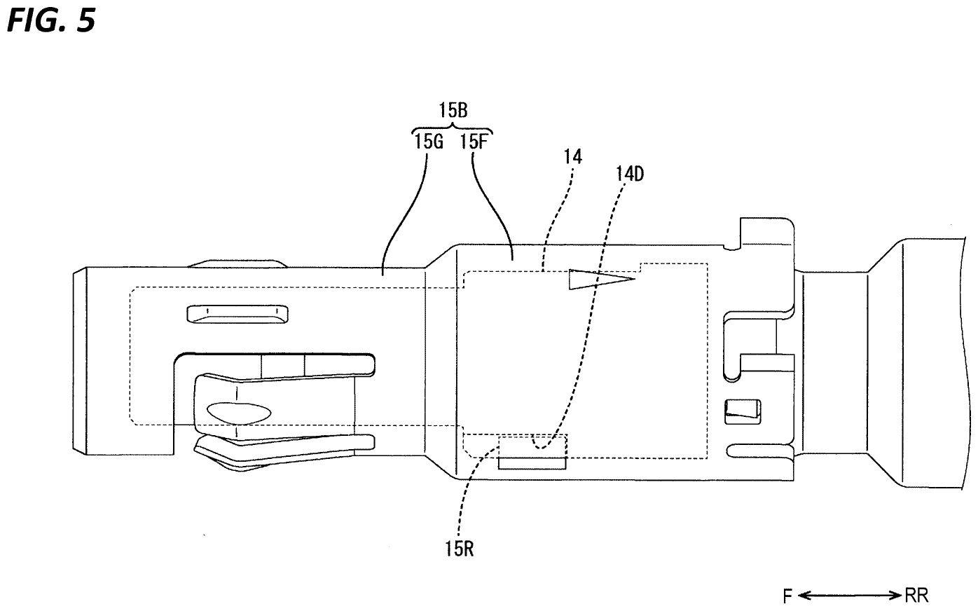

The dielectric 14 is inserted into the second outer conductor 15B from behind. That is, the dielectric 14 is arranged inside the second outer conductor 15B. As shown in FIG. 5, the third tube portion 15F of the second outer conductor 15B is provided with a projecting portion 15R projecting inward. This projecting portion 15R comes into contact with the rear end of a recess 14D formed on the outer surface of the dielectric 14 from front, whereby the dielectric 14 is prevented from moving any further forward with respect to the second outer conductor 15B.

As shown in FIG. 2, a part 14E on one side formed to be thick in the radial direction is arranged adjacent to the inner surface of the first region 15K of the second outer conductor 15B on a front side in the axial direction of the dielectric 14. A part 14F on the other side formed to be thin in the radial direction is arranged adjacent to the inner surface of the second region 15L of the second outer conductor 15B on the front side in the axial direction of the dielectric 14. That is, the dielectric 14 is arranged inside the first and second regions 15K, 15L. A thickness in the radial direction of a part facing the inner surface of the first region 15K, out of the dielectric 14, is larger than that of a part facing the inner surface of the second region 15L, out of the dielectric 14.

An interval between the inner surface of the second region 15L and the outer surface of the dielectric 14 located on this inner surface is wider than that between the inner surface of the first region 15K and the outer surface of the dielectric 14 located on this inner surface. A deflection space R, into which the resilient contact point portions 15J resiliently deformed inward are insertable, are formed between the inner surface of the second region 15L and the outer surface of the dielectric 14 arranged on this inner surface. That is, the deflection space R is formed inside the second region 15L.

The second tube portion 15D of the first outer conductor 15A is fit into the third tube portion 15F of the second outer conductor 15B, and the outer surface of the second tube portion 15D and the inner surface of the third tube portion 15F are held in contact (see FIG. 1). The second tube portion 15D of the first outer conductor 15A and the third tube portion 15F of the second outer conductor 15B are coupled, for example, by spot welding.

### [Configuration of Mating Connector]

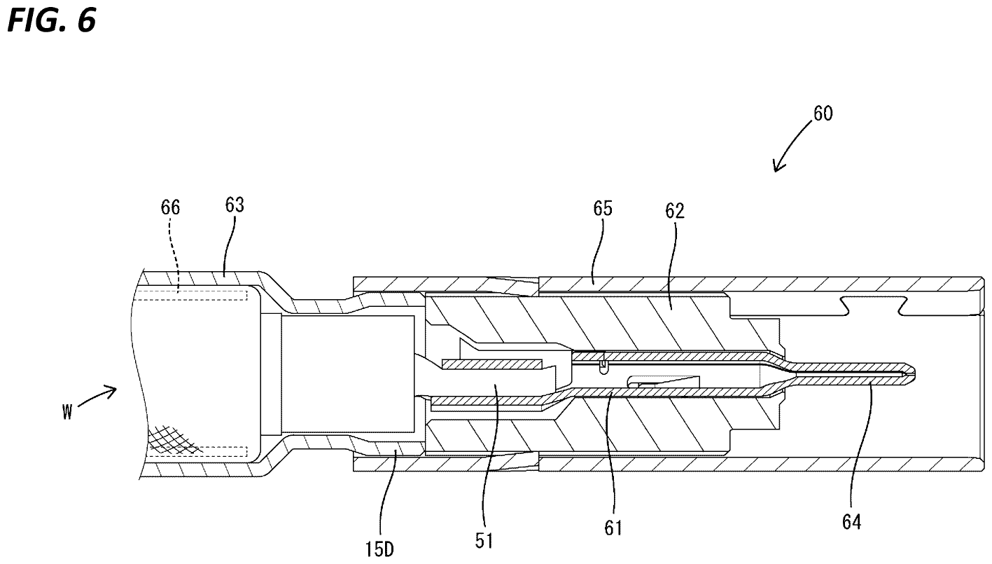

As shown in FIG. 6, the mating connector 60 is provided with a sleeve 66, the mating inner conductor 61, a first outer conductor 63, the mating outer conductor 65 and a mating dielectric 62. The mating connector 60 is mounted on an end part of a shielded wire W different from the shielded wire W on which the connector 10 is mounted. The sleeve 66 is configured similarly to the sleeve 11. The first outer conductor 63 is configured similarly to the first outer conductor 15A.

The mating inner conductor 61 is made of metal. The mating inner conductor 61 is crimped and connected to a core wire 51 of the shielded wire W and includes the tab 64 projecting forward. The mating outer conductor 65 is made of metal and has a hollow cylindrical shape. A second tube portion 15D of the first outer conductor 63 is fit into a base end part of the mating outer conductor 65. The mating outer conductor 65 and the first outer conductor 63 are coupled, for example, by spot welding. The mating outer conductor 65 surrounds the entire mating inner conductor 61.

The mating dielectric 62 is made of synthetic resin. The mating dielectric 62 is arranged between the mating inner conductor 61 and the mating outer conductor 65. The mating dielectric 62 surrounds a part of the mating inner conductor 61 except a tip part (tab 64).

### [Concerning Connection to Mating Connector]

An operation of the connector 10 when the connector 10 is connected to the mating connector 60 is described. Specifically, the tip of the fourth tube portion 15G of the second outer conductor 15B of the connector 10 is caused to face the tip of the mating outer conductor 65 of the mating connector 60. Along with this, the mating outer conductor 65 and the second outer conductor 15B are coaxially butted against each other.

The fourth tube portion 15G of the second outer conductor 15B is inserted into the mating outer conductor 65. Then, the three fixed contact point portions 15H first contact the inner surface of the mating outer conductor 65. Subsequently, the front end parts of the three resilient contact point portions 15J contact the inner surface of the mating outer conductor 65.

If the fourth tube portion 15G of the second outer conductor 15B is further inserted into the mating outer conductor 65, the three resilient contact point portions 15J are resiliently deformed by being pressed inward by the mating outer conductor 65. At this time, the three resilient contact point portions 15J enter the deformation space R formed between the dielectric 14 and the second outer conductor 15B while resiliently contacting the inner surface of the mating outer conductor 65 (see FIG. 7).

Subsequently, the bead 15Q provided on each of the three resilient contact point portions 15J contacts the inner surface of the mating outer conductor 65. In this way, the three fixed contact point portions 15H and the beads 15Q respectively provided on the three resilient contact point portions 15J contact the inner surface of the mating outer conductor 65 (see FIG. 8).

Along with this, the tab 64 of the mating inner conductor 61 is inserted into the mating connecting portion 13A of the inner conductor 13. If the fourth tube portion 15G of the second outer conductor 15B is further inserted into the mating outer conductor 65, the front end of the dielectric 14 comes into surface contact with the tip of the mating dielectric 62 (see FIG. 7). In this way, a connecting operation of electrically connecting the connector 10 and the mating connector 60 is completed. This causes two shielded wires W to be electrically connected to form an electrically conductive path for signal between the connector 10 and the mating connector 60 via the inner conductor 13 and the mating inner conductor 61. An exposed part 64A exposed from the inner conductor 13, out of the tab 64, is accommodated in the thick portion 14B of the dielectric 14 (see FIG. 7). The position of the exposed part 64A of the tab 64 is different from that of the coupling slit 15P in the axial direction of the core wire (see FIG. 7).

By the contact of the three fixed contact point portions 15H with the inner surface of the mating outer conductor 65, the mating outer conductor 65 and the fourth tube portion 15G of the second outer conductor 15B are positioned to be coaxial (see FIG. 8). Then, by the resilient contact of the three resilient contact point portions 15J with the inner surface of the mating outer conductor 65, a state where the three fixed contact point portions 15H are in contact with the inner surface of the mating outer conductor 65 can be maintained (see FIG. 8). That is, the mating outer conductor 65 and the fourth tube portion 15G of the second outer conductor 15B are maintained in a coaxially arranged state by the three resilient contact point portions 15J and the three fixed contact point portions 15H.

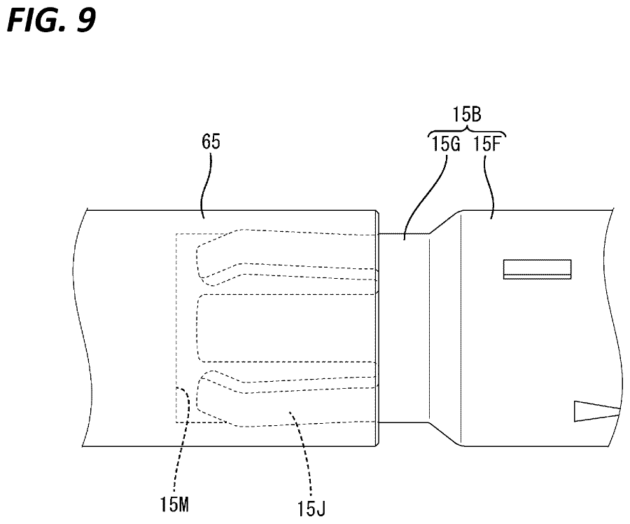

As shown in FIG. 9, the second outer conductor 15B is inserted into the mating outer conductor 65. With the second outer conductor 15B inserted in the mating outer conductor 65, the slits 15M formed in the fourth tube portion 15B of the second outer conductor 15B are surrounded by the mating outer conductor 65 when viewed from a direction orthogonal to the axis of the second outer conductor 15B. In this way, the emission of electromagnetic noise to outside via the slits 15M is prevented.

Next, functions and effects of this embodiment are described.

The connector 10 of the present disclosure is provided with the outer conductor 15 having a hollow cylindrical shape and to be crimped to the end part of the shielded wire W including the core wire 51. The outer conductor 15 is divided into two including one first region 15K and one second region 15L in the circumferential direction. The outer conductor 15 includes the fixed contact point portions 15H and the resilient contact point portions 15J. The fixed contact point portions 15H are provided in the first region 15K, are fixed in position with respect to the first region 15K and contact the inner surface of the mating outer conductor 65. The resilient contact point portions 15J are provided in the second region 15L and resiliently contact the inner surface of the mating outer conductor 65. According to this configuration, by the resilient contact of the resilient contact point portions 15J in the second region 15L with the inner surface of the mating outer conductor 65, the fixed contact point portions 15H in the first region 15K are maintained in contact with the inner surface of the mating outer conductor 65, wherefore the positions of the mating outer conductor 65 and the outer conductor 15 are easily determined in the radial direction.

The plurality of resilient contact point portions 15J of the connector 10 of the present disclosure are defined by the slits 15M formed in the second region 15L and arranged side by side in the circumferential direction. The adjacent resilient contact point portions 15J are facing one common defining slit 15N. According to this configuration, since the adjacent resilient contact point portions 15J are partitioned by one defining slit 15N, a dimension between the adjacent resilient contact point portions 15J can be easily narrowed, whereby an area of the slit 15M can be reduced. Thus, an impedance difference can be easily suppressed to be small between a part where the slits 15M are formed and a part where the slits 15M are not formed in the axial direction of the outer conductor 15.

In the connector 10 of the present disclosure, the outer conductor 15 is inserted into the mating outer conductor 65, and the slits 15M are surrounded by the mating outer conductor 65. According to this configuration, since the slits 15M are surrounded by the mating outer conductor 65, the leakage of electromagnetic noise through the slits 15M can be prevented and shielding performance can be improved.

The connector 10 of the present disclosure is provided with the dielectric 14 to be arranged inside the outer conductor 15. The thickness in the radial direction of the part facing the inner surface of the first region 15K, out of the dielectric 14, is larger than that of the part facing the inner surface of the second region 15L, out of the dielectric 14. According to this configuration, such as when an impedance on the side of the second region 15L is high, a total impedance in the radial direction can be brought closer to a target magnitude by reducing an impedance on the side of the first region 15K.

The coupling slit 15P partitioning between the ends of the resilient contact point portions 15J in the axial direction of the core wire 51 and the outer conductor 15 and connected to the defining slits 15N is formed in the second region 15L of the connector 10 of the present disclosure. The connector 10 is provided with the inner conductor 13, into which the mating tab 64 is inserted, the exposed part 64A exposed from the inner conductor 13, out of the tab 64, is accommodated in the dielectric 14, and the coupling slit 15P and the exposed part 64A of the tab 64 are different in position in the axial direction of the core wire 51. An impedance tends to be high at a position of the outer conductor 15 where the coupling slit 15P is formed and in the exposed part 64A of the tab 64. Thus, if these positions are aligned in the axial direction of the core wire 51, an impedance at that position excessively increases. According to this configuration, since these positions are made different, it is possible to prevent the formation of a part where an impedance excessively increases.

In the connector 10 of the present disclosure, the deflection space R, into which the resilient contact point portions 15J are insertable when being resiliently deformed, is formed inside the second region 15L. According to this configuration, the resilient deformation of the resilient contact point portions 15J can be made less likely to be hindered by the deflection space R.

### OTHER EMBODIMENTS

The embodiment disclosed this time should be considered illustrative in all aspects, rather than restrictive. The scope of the present invention is not limited to the embodiment disclosed this time, but is represented by claims and intended to include all changes in the scope of claims and in the meaning and scope of equivalents.

Unlike the above embodiment, four or more fixed contact point portions and four or more resilient contact point portions may be provided. Further, the number of the fixed contact point portions and that of the resilient contact point portions may be different. Further, a plurality of fixed contact point portions may be provided and one resilient contact point portion may be provided.

Unlike the above embodiment, the coupling slit may not be formed. In this case, the resilient contact point portions are defined only by the defining slits.

Unlike the above embodiment, a coupling slit may be arranged to couple rear end parts of the defining slits.

Unlike the above embodiment, the fixed contact point portions and the resilient contact point portions may be formed to project inward and contact an outer surface, which is the outer peripheral surface of the mating outer conductor.

### LIST OF REFERENCE NUMERALS

10 . . . connector
11, 66 . . . sleeve
13 . . . inner conductor
13A . . . mating connecting portion
13B . . . tubular portion
13C . . . center conductor crimping portion
13D . . . resilient piece
13E . . . contact stop portion
14 . . . dielectric
14A . . . inner conductor insertion hole
14B . . . thick portion
14C . . . contact stop receiving portion
14D . . . projection
14E . . . part on one side formed to be thick in radial direction on front side in axial direction of dielectric
14F . . . part on other side formed to be thin in radial direction on front side in axial direction of dielectric
15 . . . outer conductor
15A, 63 . . . first outer conductor
15B . . . second outer conductor
15C . . . first tube portion
15D . . . second tube portion
15E . . . reduced diameter portion
15F . . . third tube portion
15G . . . fourth tube portion
15H . . . fixed contact point portion
15J . . . resilient contact point portion
15K . . . first region
15L . . . second region
15M . . . slit
15N . . . defining slit
15P . . . coupling slit
15Q . . . bead
15R . . . projecting portion
51 . . . core wire
52 . . . coating
53 . . . braided wire
60 . . . mating connector
61 . . . mating inner conductor
62 . . . mating dielectric
64 . . . tab
64A . . . exposed part (tab)
65 . . . mating outer conductor
R . . . deflection space
W . . . shielded wire (cable)

1. A connector, comprising an outer conductor having a hollow cylindrical shape, the outer conductor being crimped to an end part of a cable including a core wire, the outer conductor being divided into two including one first region and one second region in a circumferential direction, the outer conductor including:
a fixed contact point portion provided in the first region, the fixed contact point portion being fixed in position with respect to the first region, the fixed contact point portion contacting a peripheral surface of a mating outer conductor; and
a resilient contact point portion provided in the second region, the resilient contact point portion resiliently contacting the peripheral surface of the mating outer conductor.

2. The connector of claim 1, wherein:
a plurality of the resilient contact point portions are defined by slits formed in the second region and arranged side by side in the circumferential direction, and
adjacent resilient contact point portions are facing one common slit.

3. The connector of claim 2, wherein:
the outer conductor is inserted into the mating outer conductor, and
the slits are surrounded by the mating outer conductor.

4. The connector of claim 2, comprising a dielectric to be arranged inside the outer conductor, wherein:
a thickness in a radial direction of a part facing an inner surface of the first region, out of the dielectric, is larger than a thickness in the radial direction of a part facing an inner surface of the second region, out of the dielectric.

5. The connector of claim 4, wherein:
a coupling slit partitioning between an end of the resilient contact point portion in an axial direction of the core wire and the outer conductor and connected to the slit is formed in the second region,
the connector includes an inner conductor, a mating tab being inserted into the inner conductor, an exposed part exposed from the inner conductor, out of the tab, being accommodated in the dielectric, and
the coupling slit and the exposed part of the tab are different in position in the axial direction of the core wire.

6. The connector of claim 1, wherein a deflection space is formed inside the second region, the resilient contact point portion being insertable into the deflection space when being resiliently deformed.
